(19) United States
(12) Patent Application Publication
(10) Pub. No.: US 2003/0002861 A1
(43) Pub. Date: Jan. 2, 2003

(54) Information recording apparatus

(75) Inventors: Kenji Ichige, Yokohama (JP); Junji Shiokawa, Chigasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/122,074

(22) Filed: Apr. 12, 2002

(30) Foreign Application Priority Data
Jul. 2, 2001 (JP) 2001-200301

(51) Int. Cl. H04N 5/781; H04N 5/225; G11B 7/00; G11B 5/58; G11B 7/09

(52) U.S. Cl. 386/117; 369/53.24; 386/126

(57) ABSTRACT

The information recording apparatus comprises, a vide/audio input block, a video/audio signal processing block, a recording/reproduction block, a system control block, decision means, a user input block, and a display block. The apparatus is connected to a battery and records/reproduces audio/video information onto/from a detachable recording medium. The decision means decides whether to perform finalization, thereby preventing to perform an undesirable finalization.

### BACKGROUND OF THE INVENTION

Recently, DVD (digital versatile disk) has begun to be spread as a video title medium such as a movie for entertainment at home.

Movie delivery companies are producing and delivering not only the conventional home video tapes but also DVD medium titles. Ordinary users purchase a home DVD player and can appreciate movies recorded on the DVD.

A DVD-R (DVD-Recordable), compatible with this DVD, is a writable optical disc on which a user can record video and audio information the user has. Production of a home video camera using the DVD-R as a recording medium is expected. However, in order to assure compatibility with the DVD player, a DVD-R disc should be subjected to a record finalization processing.

FIG. 2 and FIG. 3 explain the finalization processing. In the figures, the left side corresponds to an inner track and the right side corresponds to an outer track.

As shown in FIG. 2, prior to the finalization, there are a lead-in/control data zone which has been recorded already during DVD-R production and a user data zone where a video/audio data of a user is recorded. After the finalization is performed, as shown in FIG. 3, the disc area is divided into a lead-in zone, the lead-in/control data zone, a control information zone, the user data zone, and a lead-out zone in this order from the disc center toward the outer circumference. That is, the lead-in zone, the control information data, and the lead-out zone are recorded by the finalization.

The lead-out zone (A in FIG. 3) has a track width not smaller than 2 mm in case of a disc having a diameter of 8 cm but should be up to the position of 7 cm diameter as the smallest. When the data recorded by a user is small, i.e., when the user data zone has a small width, the lead-out zone becomes greater and it takes more time to write a predetermined data into the lead-out zone, thereby increasing the finalization time.

It should be noted that as an apparatus using the DVD-R, for example, there is one disclosed in U.S. Pat. No. 5,815,472.

### SUMMARY OF THE INVENTION

No consideration is taken in the home video camera for mounting a DVD-R drive, and when user has photographed for a small time and performs finalization without recognizing the time required for the finalization, the finalization takes a plenty of time, and the user should wait for a long time.

While finalization is performed, a recording medium cannot be taken out. Accordingly, as the finalization processing takes more time, the user need to wait more time before starting recording on a new medium.

On the other hand, normally, data is written into the area having no data recorded in the finalization processing. Accordingly, as the imaging time becomes shorter, the vacant area becomes greater, and more data should be written into the area upon finalization, increasing the wait time.

Because of the aforementioned, when finalization processing is performed after a short photographing time, the user should wait for a long time until replacing the recording medium with a new one, photographing, and recording start.

It is therefore an object of the present invention to reduce the wait time for the finalization processing, so that a user can rapidly start recording on a new recording medium.

In order to achieve the aforementioned object, according to the present invention, finalization specified by a user is not performed unconditionally. More specifically, a predetermined condition is provided for performing the finalization and if the condition is not satisfied, the finalization is not performed.

And when the condition is satisfied, the finalization is performed.

The predetermined condition may be predetermined time as a processing time for the finalization and if more than the predetermined time is required for finalization, the finalization is not performed.

It should be noted that the aforementioned predetermined time may be decided according to remaining power which can be supplied from the battery to the information recording apparatus or may be decided statistically by checking how much time users can wait without feeling illustration.

Moreover, in order to achieve the aforementioned object, an information recording apparatus according to the present invention for recording information on a writable information recording medium comprises: recording means for recording information onto the recording medium; finalization means for performing finalization of the recording medium; decision means for deciding whether to perform the finalization by the finalization means; and control means for controlling the information recording apparatus and when the decision means decides negative, the finalization is not performed.

Moreover, in order to achieve the aforementioned object, the information recording apparatus according to the present invention, further comprises: finalization time estimation means for estimating a time required for the finalization; and time comparison means for comparing a time estimated by the finalization time estimation means to a predetermined time; and when the time required for the finalization time is decided to be greater than the predetermined time by the time comparison means, the decision means results in positive.

When the decision results is No, the finalization is not performed.

In order to achieve the aforementioned object, the information recording apparatus further comprises a battery for supplying power to the information recording apparatus; and operation time estimation means for estimating a time that the information recording apparatus can be operated by the battery; wherein the predetermined time is set within a range of the operable time estimated by the operation time estimation means. Accordingly, the decision results in positive and the finalization is performed. Alternatively, by detecting the power quantity that can be supplied from the battery to the information recording/reproduction apparatus, the finalization is performed when the detected power quantity is equal to or greater than a predetermined power quantity. On the contrary, when the power quantity detected is smaller than the predetermined power quantity, the finalization is not performed.

Moreover, in order to achieve the aforementioned object, in the information recording apparatus, the decision means includes: remaining quantity detection means for detecting remaining data quantity recordable on the recording medium; and comparison means for comparing the data quantity detected by the remaining quantity detection means with a predetermined data quantity; wherein if the data quantity detected by the remaining quantity detection means exceeds the predetermined data quantity, then the decision means results in No.

Since the decision result is No, the finalization is not performed.

Moreover, in order to achieve the aforementioned object, the information recording apparatus further comprises: remaining quantity detection means for detecting remaining data quantity recordable on the recording medium, wherein the finalization time estimation means estimate a time required for the finalization according to data quantity detected by the remaining quantity detection means.

Moreover, in order to achieve the aforementioned object, the information recording apparatus according to the present invention further comprises: notification means and when the finalization is not performed, the notification means notifies that the finalization is not performed.

Alternatively, a condition is provided for deciding whether to perform the finalization and when the condition is not satisfied, that is displayed by the notification means and a display processing circuit.

It should be noted that even when that the condition is not satisfied is displayed, if a user wants to perform the finalization and specifies the finalization, by the user input processing circuit, the control of finalization may be modified so as to force to perform the finalization.

Moreover, in order to achieve the aforementioned object, in the information recording apparatus according to the present invention, the finalization time estimation means estimates the time required for the finalization as follows:

T=(D1−D2)/S1+P1

wherein T is a time required for the finalization; D1 is a recordable capacity of the recording medium; D2 is a recorded capacity of the recording medium; S1 is processing speed (including the finalization speed) of the information recording apparatus; and P1 is a processing time overhead.

It should be noted that control of the aforementioned processing blocks and means or condition decision is performed by the system control circuit. However, it is also possible to provide a processing circuit for control of the processing blocks and means or the condition decision separately from the system control circuit.

Here, the finalization is performed to a recording medium having information (including audio and video information) so as to be reproduced in a reproduction apparatus.

### BRIEF DESCRIPTION OF THE DRAWINGS

FIG. 1 is a block diagram showing configuration of a first embodiment of the present invention.

FIG. 2 shows a record state prior to the DVD-R finalization.

FIG. 3 shows a record state after the DVD-R finalization.

FIG. 4 is a block diagram showing configuration of a system control device (system control means) 6.

FIG. 5 shows data contents to be stored in memory means 43.

FIG. 6 is a flowchart related to finalization control according to a first embodiment of the present invention.

FIG. 7 is a block diagram showing configuration of a second embodiment of the present invention.

FIG. 8 is a flowchart related to finalization control according to the second embodiment of the present invention.

FIG. 9 is a block diagram of an information recording/reproducing apparatus according to a third embodiment of the present invention.

FIG. 10 shows an example of message shown to a user according to the present invention.

FIG. 11 shows another example of message shown to a user according to the present invention.

FIG. 12 shows still another example of message shown to a user according to the present invention.

### DESCRIPTION OF EMBODIMENTS

Description will now be directed to embodiments of the present invention with reference to the drawings.

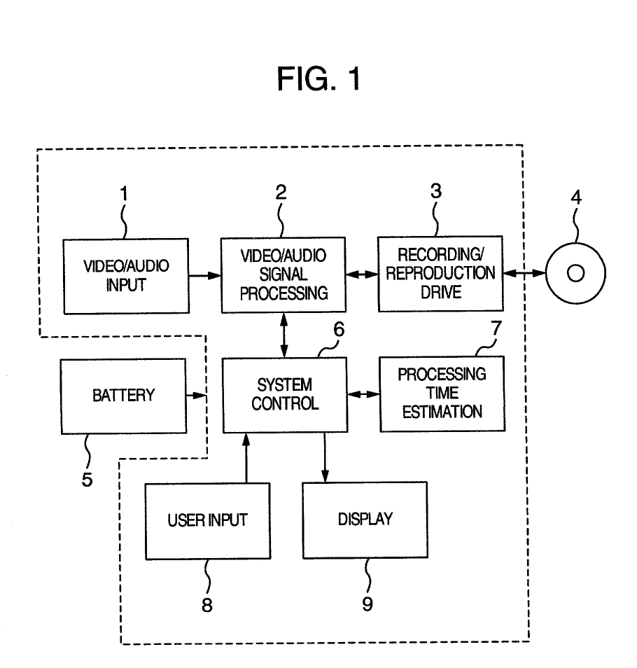

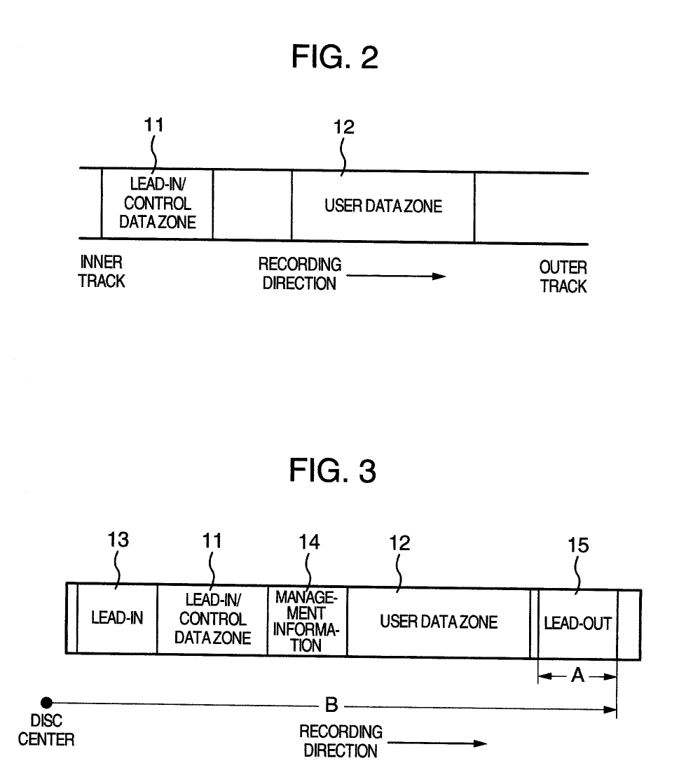

FIG. 1 is a block diagram showing configuration of video camera using DVD-R as a recording medium according to a first embodiment of the present invention. The video camera includes: video/audio input means 1; video/audio signal processing means 2; a DVD-R drive device having recording means, reproducing means or finalization processing means 3; a DVD-R as a recording medium 4; a battery 5 for operating a video camera (indicated by a dotted line in FIG. 1); a system control device 6; processing time estimation means 7; user input means 8; and a display device 9. These components are contained in a frame that can be carried as a video camera, which performs video/audio information recording and reproduction according to operation by a user.

The DVD-R drive device 3 has a built-in disc removal/mounting mechanism, so that a user can replace the DVD-R 4.

A user operates the video camera by using the user input means 8 arranged at a an operable position on the camera frame. The user input means 8 includes a power switch for turning on/off the power source, start and end indicating buttons of recording or reproduction, and the like. When the user turns on the power switch, the video camera enters an operation state. While the video camera is operating, power required in the respective blocks is supplied from the battery 5.

In the operation state, the system control device 6 controls the respective function blocks, causes the entire system to operate to take (record) or reproduce video and audio data, and finalize the DVD-R disc so as to be compatible with a DVD player.

During imaging, the video/audio means 1 converts image and sound of a subject and surroundings into an electric signal and outputs it to the signal processing means 2. The signal processing means 2 performs signal processing of the video and audio data and outputs them to the DVD-R drive 3. The signal processing includes data compression of the video and audio data. The DVD-R drive records the received data into the DVD-R.

During reproduction, the DVD-R drive 3 reads out data from the DVD-R and the video/audio signal processing means 2 and the system control device 6 restores the data and performs a predetermined processing to reproduce the image and sound in the display device 9.

During reproduction, by providing external output means of video/audio information, it is possible to display the video/audio information on an external display device other than a television.

During recording, the processing time estimation means 7 with the system control device 6 estimates the time required for finalization.

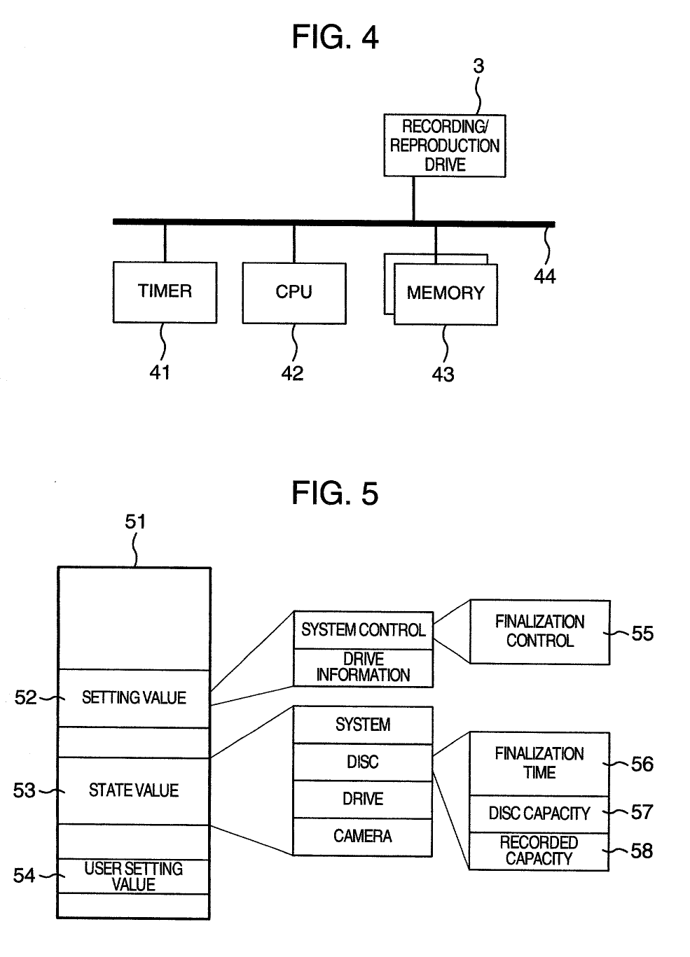

FIG. 4 shows a configuration example of the system control device 6. The system control device includes a timer, a CPU 42, a memory 43, and a CPU bus 44. In this configuration example, the CPU 42 and the memory 43 storing its-program and data executes processing including the function of the processing time estimation means 7. The CPU 9 is connected to the other system components via the CPU bus 44. The memory 43 is memory means containing a program to be executed by the CPU 42 and stores data. The timer 41 is time measuring means with which the CPU 42 can fetch information about a current time or time lapse.

The system control means 6 performs recording processing according to user operation input from the user input means 8 and stores management data such as a recording time and recording data quantity in the memory 43 for management. FIG. 5 shows a memory layout example of part of the memory 43. A part of a data region 51 includes a setting value region 52, a state value region 53, and a user setting value region 545. The setting value region stores various parameters which determine the operation of the system and includes a system control information area and a drive information area. The system information area includes finalization control information 55. The finalization control information 55 contains a set value (TO) allowing finalization and information whether to allow finalization processing in a DVD-R currently used. The state value region 53 stores current values concerning states of the system, the disc, the drive, and the camera. These values are managed by the program executed by the CPU 42 and updated from time to time. The disc state values include a finalization time 56, a disc capacity 57, and recorded capacity 58.

The finalization time can be determined from the disc state (D) and the system setting value (S). One of the calculation methods is based on the remaining DVD-R recording capacity, i.e., the disc capacity (D1) subtracted by the disc recorded capacity (D2) to obtain (D1−D2) and the DVD-R drive processing speed (S1) as follows.

T=(D1−D2)/S1+P1 (Equation 1)

wherein D1 represents the disc capacity 57; D2 represents the recorded capacity 58; and S1 represents finalization speed of the drive stored in the drive information of the setting value region 52. Overhead portion (P1) of the processing time is involved in the equation 1.

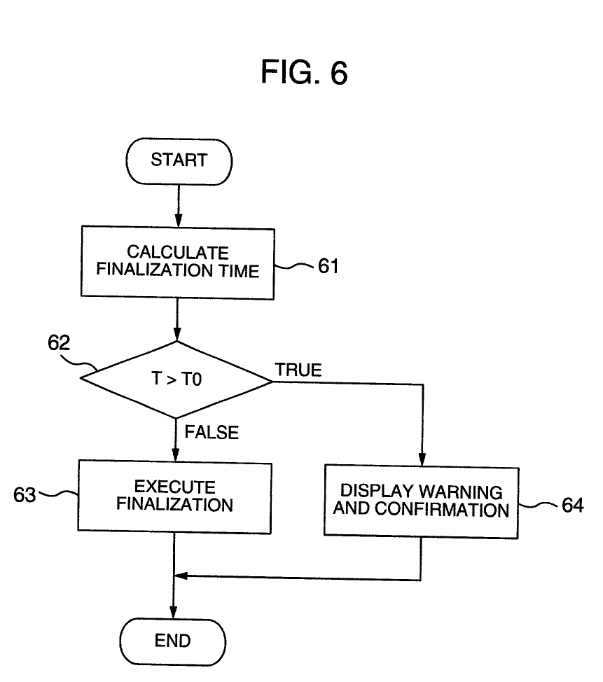

FIG. 6 is a flowchart showing finalization control executed by the CPU 42. When the finalization processing is requested by the user, this processing flow is executed. In step 61, the finalization processing time T is calculated. In step 62, it is determined whether the processing time T exceeds a predetermined time (allowed time) T0. If No, i.e. T is not greater than T, then control is passed to step 63, where control required for the finalization processing is performed. If Yes, i.e. T is greater than T, then control is passed to step 64, where a warning message is displayed to the user by the display device 9 and enters a wait state for user confirmation. The finalization processing is terminated after execution of the aforementioned processes.

In the aforementioned case, finalization is denied if the finalization processing time exceeds the allowed time TO. However, only for the skilful user who knows details of the finalization processing, a part of the user setting region 54 may be modifiable by operation via the user input means 8 so as to force to perform the finalization processing. For this, the aforementioned user setting value region 54 includes a flag indicating a skilful user in a region for setting a value for finalization, which are referred by the program executed by the system control means 6.

In this embodiment, the video camera automatically determines whether the finalization is to be performed or not for the currently installed disk, and when the finalization is not appropriate, it is possible to prohibit the finalization processing. This prevents performing finalization processing by a careless mistake of the user and waiting for the next take.

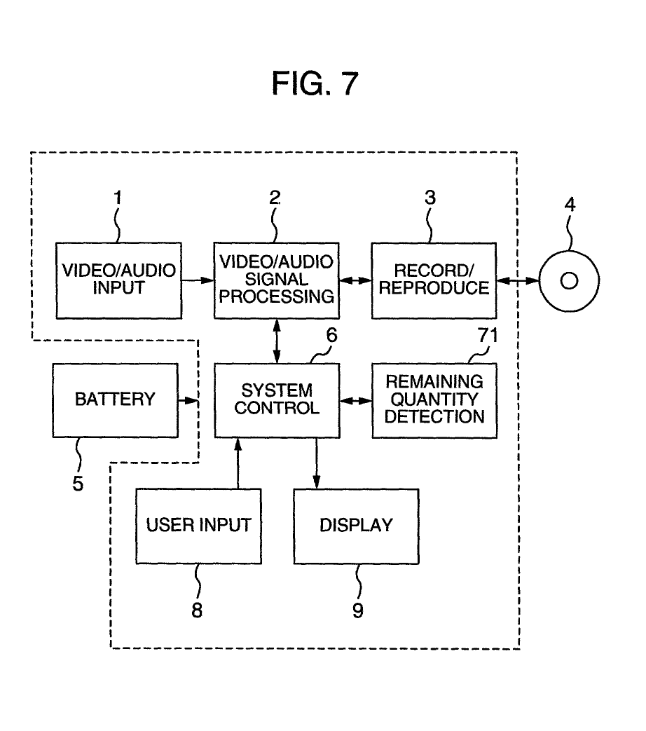

FIG. 7 shows a configuration of the second embodiment of the present invention. Like components are denoted by like reference symbols. The processing time estimation means 7 in the first embodiment is replaced by remaining quantity detection means 71. The video/audio recording/reproduction processing is identical to that in the first embodiment.

The system control means 6 controls finalization processing in cooperation with the remaining quantity detection means 71. The system control means could be configured in the same configuration to that of the first embodiment. In this embodiment, the finalization processing is prohibited when the remaining quantity exceeds a predetermined value.

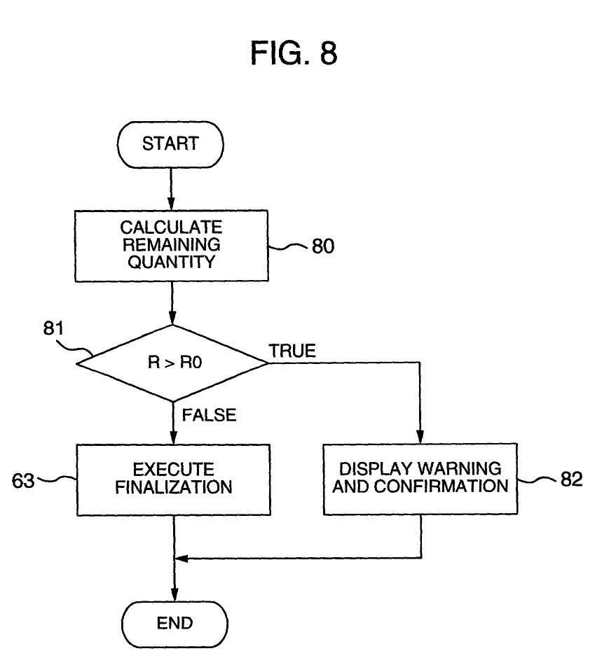

FIG. 8 is a flowchart showing finalization control in the second embodiment. In step 80, a disc remaining quantity R is calculated. Step 81 determines whether the disc remaining quantity R exceeds a predetermined value R0. If No (R does not exceed the value R0), control is passed to step 63, where control is performed to execute finalization. If Yes (R exceeds the R0), a warning is displayed in step 82 for waiting for confirmation by the user. The finalization processing is terminated after execution of the aforementioned processes.

Calculation of the remaining quantity R is performed as explained in the first embodiment. That is the system control means 6 manages the disc capacity D1 and the recorded quantity D2.

Moreover, for skillful users having a sufficient operation knowledge, it is possible to provide a set value R0 modification method so as to force to perform finalization in the same manner mentioned in the first embodiment.

Next, explanation will be given on a third embodiment.

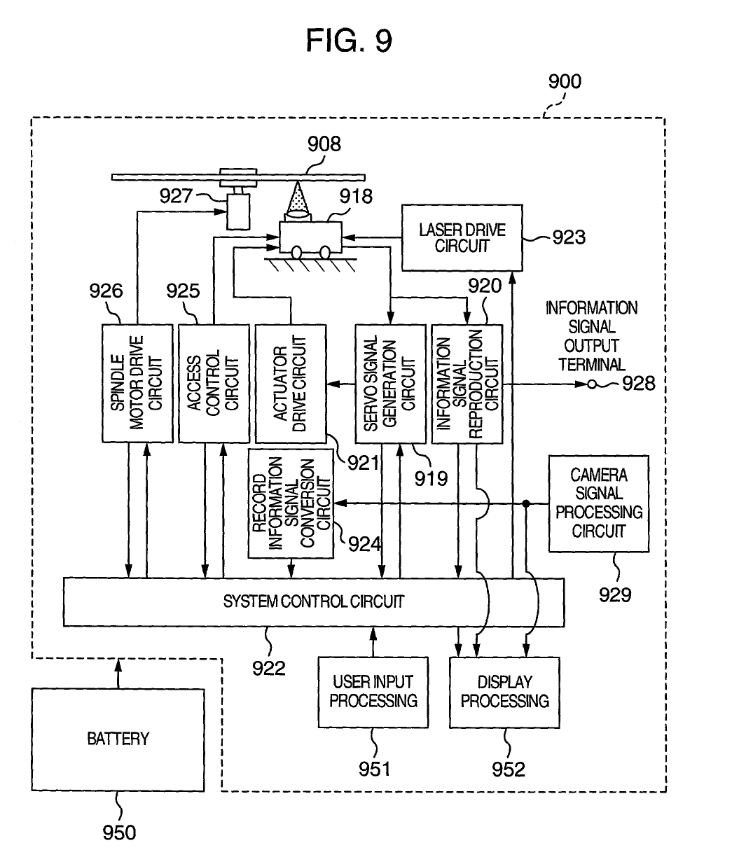

FIG. 9 is a block diagram showing an information recording/reproduction apparatus 900 for performing information recording and reproduction. Various signals detected by an optical pickup 918 are supplied to a servo signal generation circuit 919 and an information signal reproduction circuit 920 in a signal processing circuit. The servo signal generation circuit generates a focusing error signal and a tracking error signal suitable for each optical disc 908 from the supplied detection signals. In accordance with these error signals, an actuator drive circuit 921 drives an objective lens actuator in the optical pickup 918 to adjust the position of the objective lens. Moreover, in the information signal reproduction circuit 920, the detected signal is used to reproduce an information signal recorded on the optical disc 908 and the information signal is output to an information signal output terminal 928. Portions of the signals generated and reproduced by the servo signal generation circuit 919 and information signal reproduction circuit 920 are supplied to a system control circuit 922.

Moreover, a record information, optically taken and converted into an electric signal in a camera signal processing circuit 929, is supplied to a record information signal conversion circuit 924. In the record information signal conversion circuit 924, the electric signal is converted into a record signal, which is supplied to a system control circuit 922 to drive a laser light circuit 923 and to record the record signal on the optical disc 908. An access control circuit 925 and a spindle motor drive circuit 926 are connected to the system control circuit 922, the former controlling the access direction and position of the optical pickup 918 and the latter controlling a spindle motor 927 for the optical disc.

The finalization processing is performed according to control by the system control circuit 922 onto the optical disc 908 via the laser light source turning-on circuit 923 and the optical pickup 918.

In the third embodiment of FIG. 9, the decision whether to perform the finalization processing is performed by the system control circuit 922. It should be noted that when a user controls the aforementioned information recording/reproduction apparatus, the user operates the user input processing circuit 951. Processing states of the information recording/reproduction apparatus may be displayed on a display unit included in a display processing circuit 952. Especially in case of the information recording/reproduction apparatus recording information obtained from the camera signal processing circuit 929, a liquid crystal screen such as an LCD can be provided in the display processing circuit 952, thereby enabling display and monitoring of video/audio information.

It should be noted that the display processing circuit 852 may display and monitor record information or information which is recorded onto the optical disc by receiving a signal from the information signal reproduction circuit 920 or information reproduced from the optical disc.

The information recording/reproduction apparatus 900 in FIG. 9 is connected to a battery 950 from which power is supplied and can be used as a portable type. Here, instead of connecting to the battery 950, it is also possible to connect a domestic AC power source by providing a power source circuit for that. In this case, the apparatus is used as a stationary type.

Moreover, in the aforementioned case, a video/audio signal from the camera signal processing circuit 929 is provided as an input source. However, it is also possible to provide another signal source and its output signal is used as an input signal to be recorded. Alternatively, it is also possible to provide a signal input terminal and an external signal supplied from outside through the terminal may be recorded.

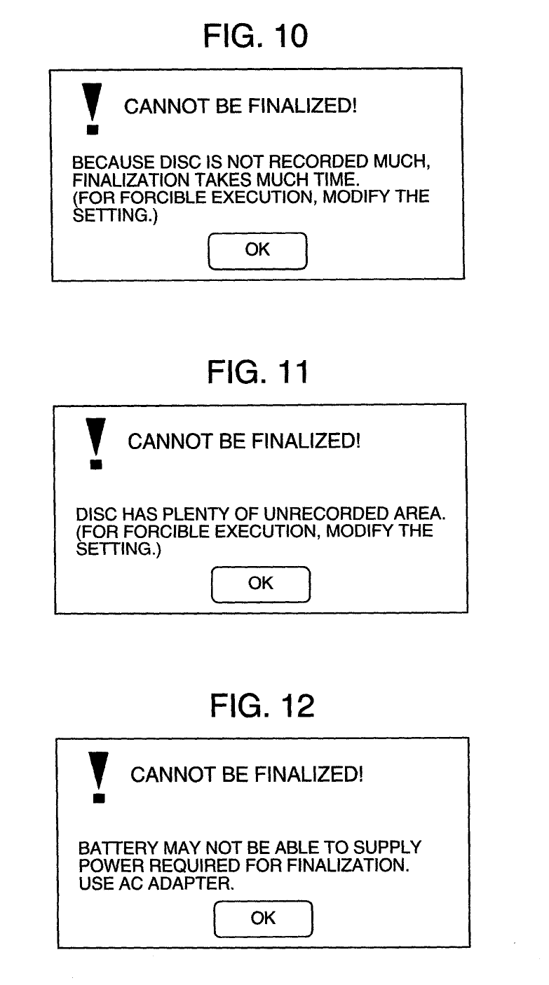

FIG. 10 and FIG. 12 show warning message notified to the user displayed in step 64 of the first embodiment in FIG. 6. That is, finalization takes a plenty of time and a user should wait for a long time if the finalization is performed unconditionally. Moreover, when power is supplied from a battery, if power supply runs out during a finalization processing, the finalization fails and there is a worst case that the optical disc cannot be reproduced. Thus, the messages of FIG. 10 and FIG. 12 warn the user that the finalization takes a long time and asks the user to perform finalization even it takes a plenty of time.

Moreover, FIG. 11 shows a message displayed in step 82 in the second embodiment. That is, it is warned that unrecorded data capacity is large and the message also asks the user to confirm finalization is really required. This message, like the message in FIG. 10, can prevent the user from waiting for a long time by performing the finalization processing. Furthermore, if the finalization is performed, any more information cannot be written. If the finalization processing is performed by a careless operation, the optical disc cannot be used for recording any more. Accordingly, the message of FIG. 11 can prevent finalization by an incorrect operation.

It should be noted that FIG. 10 to FIG. 12 are only examples and it is possible to use various message contents, design, and display ways, including a message where the user can select processes related to the finalization.

For an example, it is possible to ask the user whether to force to perform finalization: “Finalization forced to be performed? YES/NO”, and if YES is selected, the finalization is forced to be performed. In this case, the condition setting may be modified so as to be able to perform the finalization or the process is jumped to step 63 for performing the finalization.

Moreover, while explanation has been given on a case that the optical disc is a DVD-R in the embodiments, the present invention is not limited to this but can be applied to a recording medium capable of recording with a higher density than a CD or DVD.

In the aforementioned embodiments, the video camera automatically decides whether to perform the finalization processing according to a disc remaining capacity and can prevent a case that the user erroneously performs finalization and waits for a long time until the next take can be performed.

It should be noted that the aforementioned predetermined time can be decided according to the power quantity that can be supplied from the battery to the information recording device.

The predetermined time may also be decided statistically by testing a plurality of users when they feel that the waiting time is long.

It should be noted that in the aforementioned embodiments, the decision whether to perform the finalization is made according to an electric power quantity and a comparison of a non-recorded capacity of a recording medium and a predetermined time.

However, instead of comparing the time values, it is also possible to decide whether to perform the finalization according to a comparison of an electric power quantity and a non-recorded capacity of the recording medium with respective predetermined values.

For an example, a time is calculated from a power quantity supplied from a battery and the time is compared to a predetermined time. If the time obtained from the power quantity supplied from the battery is greater than the predetermined time, the finalization is performed.

However, instead of calculating time from the power quantity from the battery, it is possible to compare the power quantity supplied from the battery with a predetermined power quantity. If the former is greater than the latter, the finalization is performed. In this case, the power supply required for finalization is assured and there is no danger of finalization failure due to shortage of power from the battery.

It should be noted that the respective processors, control of means, or conditional decisions in the aforementioned embodiments are performed by the system control circuit. However, it is also possible to provide a separate processing circuit for the respective processors, control of means, and conditional decision without using the system control circuit.

According to the aforementioned embodiments, the video camera automatically recognizes a recorded state and can decide whether the finalization is possible. For example, there is no danger that the finalization is performed by an erroneous operation by the user and the user should wait for a long time until the user can again take video.

Accordingly, it becomes possible to reduce the wait time when the finalization is performed and can soon start recording/photographing on a new medium.

The present invention can prevent a careless execution of the finalization processing.

It should be further understood by those skilled in the art that the foregoing description has been made on embodiments of the invention and that various changes and modifications may be made in the invention without departing from the spirit of the invention and the scope of the appended claims.

What is claimed is:

1. An information recording apparatus for recording information on a writable information recording medium, said apparatus comprising:
recording means for recording information on the recording medium;
finalization means for performing finalization to the recording medium;
decision means for deciding whether to perform the finalization by the finalization means; and
control means for controlling the information recording apparatus,
wherein when the decision means results in No, the finalization is not performed.

2. The information recording apparatus as claimed in claim 1, wherein the decision means includes:
finalization time estimation means for estimating a time required for the finalization; and
time comparison means for comparing a time estimated by the finalization time estimation means to a predetermined time;
wherein when the time required for the finalization time is decided to be greater than the predetermined time by the time comparison means, the decision means results in No.

3. The information recording apparatus as claimed in claim 2, the apparatus further comprising:
a battery for supplying power to the information recording apparatus; and
operation time estimation means for estimating a time that the information recording apparatus can be operated by the battery;
wherein the predetermined time is set within a range of the operable time estimated by the operation time estimation means.

4. The information recording apparatus as claimed in claim 1, wherein the decision means includes:
remaining quantity detection means for detecting remaining data quantity recordable on the recording medium; and
comparison means for comparing the data quantity detected by the remaining quantity detection means with a predetermined data quantity;
wherein if the data quantity detected by the remaining quantity detection means exceeds the predetermined data quantity, then the decision means results in No.

5. The information recording apparatus as claimed in claim 2, the apparatus further comprising:
remaining quantity detection means for detecting remaining data quantity recordable on the recording medium,
wherein the finalization time estimation means estimate a time required for the finalization according to data quantity detected by the remaining quantity detection means.

6. The information recording apparatus as claimed in claim 3, the apparatus further comprising:
remaining quantity detection means for detecting remaining data quantity recordable on the recording medium,
wherein the finalization time estimation means estimate a time required for the finalization according to data quantity detected by the remaining quantity detection means.

7. The information recording apparatus as claimed in claim 1, the apparatus further comprising:
notification means;
wherein when the finalization is not performed, the notification means notifies that the finalization is not performed.

8. The information recording apparatus as claimed in claim 2, wherein the finalization time estimation means estimates the time required for the finalization as follows:
T=(D1−D2)/S1+P1
wherein T is a time required for the finalization; D1 is a recording capacity of the recording medium; D2 is a recorded capacity of the recording medium; S1 is processing capability, including the finalization speed, of the information recording apparatus; and P1 is a processing time overhead.

9. An information recording apparatus for recording information on a writable information recording medium, the apparatus comprising:
a spindle motor for rotating the recording medium;
a spindle motor drive circuit for controlling rotation of the spindle motor;
an optical pickup for reading/writing from/to the recording medium;
a servo signal generation circuit for generating a focusing control signal and a tracking control signal from a detection signal detected by the pickup;
an actuator drive circuit for controlling a position of an objective lens of the optical pickup according to the focusing control signal and the tracking control signal;
a camera signal processing circuit for converting video information obtained via an optical system into an electric signal;
record information signal conversion circuit for converting the signal from the camera signal processing circuit into a laser drive record signal;
a laser light source turning-on circuit for recording the record signal onto the recording medium by the optical pickup according to the laser drive record signal;
a user input processing circuit for accepting user input;
a display processing circuit for displaying a signal from the camera signal processing circuit or the state of the information recording apparatus; and
a system control circuit for controlling the spindle motor drive circuit, the servo signal generation circuit, the actuator drive circuit, the camera signal processing circuit, the record information signal conversion circuit, and the laser light source turning-on circuit;
wherein when a finalization processing of the recording medium is specified according to the system control circuit, the system control circuit decides a condition whether to perform the finalization processing and if the condition is satisfied, the finalization is actually performed.

10. The information recording apparatus as claimed in claim 9, wherein when the finalization processing of the recording medium is specified according to control of the system control circuit, if the system control circuit decides that recordable data quantity on the recording medium is not greater than a predetermined quantity, then the finalization is actually performed.

11. The information recording apparatus as claimed in claim 9, wherein the apparatus can be connected to a battery for supplying power; and
when finalization is of the recording medium is specified according to control of the system control circuit, if the system control circuit detects that power which can be supplied from the battery to the information recording apparatus is equal to or smaller than a predetermined power quantity, the finalization processing is actually performed.

12. The information recording apparatus as claimed in claim 9, wherein when the finalization of the recording medium is specified according to control of the system control circuit, the system control circuit estimates a time required for the finalization processing, and if the estimated time is equal to or smaller than a predetermined time, the finalization processing is actually performed.

13. The information recording apparatus as claimed in claim 9, wherein when the finalization of the recording medium is specified by control of the system control circuit, the system control circuit decides a condition of the finalization and if the condition is not satisfied, the system control circuit causes the display processing circuit to display that the condition is not satisfied.

14. The information recording apparatus as claimed in claim 10, wherein when the finalization of the recording medium is specified by control of the system control circuit, the system control circuit decides a condition of the finalization and if the condition is not satisfied, the system control circuit causes the display processing circuit to display that the condition is not satisfied.

15. The information recording apparatus as claimed in claim 11, wherein when the finalization of the recording medium is specified by control of the system control circuit, the system control circuit decides a condition of the finalization and if the condition is not satisfied, the system control circuit causes the display processing circuit to display that the condition is not satisfied.

16. The information recording apparatus as claimed in claim 12, wherein when the finalization of the recording medium is specified by control of the system control circuit, the system control circuit decides a condition of the finalization and if the condition is not satisfied, the system control circuit causes the display processing circuit to display that the condition is not satisfied.

17. The information recording apparatus as claimed in claim 9 wherein when the finalization of the recording medium is specified by control of the system control circuit, the system control circuit decides a condition of the finalization and if the condition is not satisfied, the system control circuit causes the display processing circuit to display that the condition is not satisfied, and if the finalization is specified to be performed by the user input processing circuit, then the finalization is performed.

18. The information recording apparatus as claimed in claim 10 wherein when the finalization of the recording medium is specified by control of the system control circuit, the system control circuit decides a condition of the finalization and if the condition is not satisfied, the system control circuit causes the display processing circuit to display that the condition is not satisfied, and if the finalization is specified to be performed by the user input processing circuit, then the finalization is performed.

19. The information recording apparatus as claimed in claim 11 wherein when the finalization of the recording medium is specified by control of the system control circuit, the system control circuit decides a condition of the finalization and if the condition is not satisfied, the system control circuit causes the display processing circuit to display that the condition is not satisfied, and if the finalization is specified to be performed by the user input processing circuit, then the finalization is performed.

20. The information recording apparatus as claimed in claim 12 wherein when the finalization of the recording medium is specified by control of the system control circuit, the system control circuit decides a condition of the finalization and if the condition is not satisfied, the system control circuit causes the display processing circuit to display that the condition is not satisfied, and if the finalization is specified to be performed by the user input processing circuit, then the finalization is performed.

21. An information recording apparatus for recording information on a writable information recording medium, the apparatus comprising:
a spindle motor for rotating the recording medium;
a spindle motor drive circuit for controlling rotation of the spindle motor;
an optical pickup for reading/writing from/to the recording medium;
a servo signal generation circuit for generating a focusing control signal and a tracking control signal from a detection signal detected by the pickup;
an actuator drive circuit for controlling a position of an objective lens of the optical pickup according to the focusing control signal and the tracking control signal;
a camera signal processing circuit for converting video information obtained via an optical system into an electric signal;
record information signal conversion circuit for converting the signal from the camera signal processing circuit into a laser drive record signal;
a laser light source turning-on circuit for recording the record signal onto the recording medium by the optical pickup according to the laser drive record signal;
a user input processing circuit for accepting user input;
a display processing circuit for displaying a signal from the camera signal processing circuit or the state of the information recording apparatus; and
a system control circuit for controlling the spindle motor drive circuit, the servo signal generation circuit, the actuator drive circuit, the camera signal processing circuit, the record information signal conversion circuit, and the laser light source turning-on circuit;
wherein when a finalization processing of the recording medium is specified according to the system control circuit, the system control circuit decides a condition whether to perform the finalization processing and if the condition is not satisfied, the finalization is not performed.
